(19) United States
(12) Patent Application Publication
(10) Pub. No.: US 2005/0072444 A1
(43) Pub. Date: Apr. 7, 2005

(54) Method for processing plasma processing apparatus

(76) Inventors: Shigeru Shirayone, Shunan-shi (JP); Tetsuo Ono, Iruma-shi (JP); Naoshi Itabashi, Tokyo (JP); Motohiko Yoshigai, Hikari-shi (JP); Takahiro Abe, Hofu-shi (JP); Takahiro Shimomura, Kudamatsu-shi (JP); Hiroyuki Kitsunai, Niihari-gun (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/791,856

(22) Filed: Mar. 4, 2004

(30) Foreign Application Priority Data
Oct. 3, 2003 (JP) 2003-345974

(51) Int. Cl. B08B 3/12

(52) U.S. Cl. 134/1.3; 134/1.1; 134/1.2; 134/1

(57) ABSTRACT

A method for processing a plasma processing apparatus having plasma generating means 3, 8, 10, 13 through 15 for generating plasma within a processing chamber, a high-frequency power applying means 18 for applying high-frequency power to an object 17 to be processed, a processing chamber 1 to which an evacuating device 7 is connected and capable of having its interior evacuated, and a gas supply device (not shown) for the processing chamber, wherein the method comprises mounting a Si wafer 17 on an electrode 4 for holding the object to be processed, introducing hydrobromic gas and chlorine gas into the processing chamber and generating plasma, and removing the aluminum-based deposit adhered to the interior of the processing chamber.

### FIELD OF THE INVENTION

The present invention relates to a method for processing a plasma processing apparatus that generates aluminum-based reaction products, and especially relates to a method for processing a plasma processing apparatus preferably used to perform an etching process using plasma to a substrate to be processed, such as a semiconductor substrate.

Furthermore, the present invention relates to a plasma processing method, and especially relates to a method for cleaning a vacuum container of a plasma processing apparatus for providing an etching process to a substrate such as a semiconductor wafer using plasma, or for depositing a film to a substrate using plasma.

### DESCRIPTION OF THE RELATED ART

The present invention is applied to a plasma processing apparatus utilizing plasma for the manufacture of semiconductor elements. A prior art example is explained in the following, taking an ECR (electron cyclotron resonance) type plasma processing apparatus as an example. In this type of apparatuses, plasma is generated in a vacuum container by applying a magnetic field thereto from the exterior and supplying electromagnetic waves of the microwave band or UHF band. The magnetic field causes cyclotron motion of the electrons, and efficient generation of plasma is made possible by resonating the frequency of the cyclotron and the frequency of the electromagnetic waves. When this apparatus is used to etch wafers, halogen gases such as chlorine gas and fluorine gas are used as the gas for generating plasma. In order to accelerate the ions being incident on the wafer, a high-frequency voltage is applied to the wafer. This arrangement enables perpendicular etching of the wafer, required for the manufacture of semiconductor elements. The power applied to the wafer is hereinafter called a bias power. When it is necessary to deposit a film on the wafer, material gas such as SiH₄ gas can be used to deposit a polycrystal Si film on the wafer.

According to this apparatus, after a certain processing time has passed, deposits from material gas and reaction products are formed inside the container. When such deposits occur, the status of the plasma is changed, causing the etching properties to change with time, or the deposits may fall on the surface of the wafer as contaminants, causing yield degradation. Therefore, after a certain time has passed, it becomes necessary to clean the inner walls of the vacuum processing chamber.

In a semiconductor manufacturing process, a dry etching process using plasma is generally carried out. There are various types of plasma processing apparatuses that can be used to carry out the dry etching.

In general, a plasma processing apparatus comprises, for example, a vacuum container, a gas supply system connected to the container, an evacuation system for maintaining the pressure inside the processing chamber to a predetermined level, an electrode for supporting a substrate, an antenna for generating plasma inside the vacuum container, and a shower plate for supplying processing gas evenly into the vacuum container. By supplying high frequency power to the antenna, the processing gas supplied through the shower plate into the processing chamber is dissociated and plasma is generated, and thus, the etching of the substrate mounted on the substrate-holding electrode is performed.

In such a plasma etching apparatus, a portion of the reaction product generated by the etching of the substrate may adhere on the inner walls of the processing chamber without being evacuated, and such reaction products may fall off the inner walls and become particles, or may cause the density and composition of the plasma to change due to the variation in status of the inner walls of the chamber, or may even cause the etching properties to vary.

One method for removing the reaction products adhered to the inner walls of the processing chamber is a dry cleaning process using plasma. According to this dry cleaning process, if the reaction products adhered to the inner walls of the processing chamber are silicon-based, for example, by generating plasma using fluorine-based gases (such as sulfur hexafluoride), the silicon-based reaction products adhered to the inner walls of the processing chamber react with the fluorine generated in the plasma and turn into silicon fluoride, which are removed from the inner walls and evacuated outside the processing chamber. By carrying out such processes for removing reaction products at appropriate time intervals (such as per processing a certain number of wafers, or per a certain lot), the inner wall of the processing chamber can be maintained in a state where no reaction products are adhered thereto.

In order to remove aluminum-based reaction products, it is considered effective to perform dry cleaning with plasma generated using chlorine-based gases which are generally used for etching aluminum. However, a portion of the aluminum-based reaction products may have turned into aluminum fluoride (AlF), and some aluminum-based reaction products (such as AlF) cannot be removed by the dry cleaning process using chlorine-gas plasma.

That is, if aluminum-based reaction products or the aluminum sputtered from members inside the processing chamber are adhered to the inner walls of the processing chamber, the prior-art dry cleaning process using the plasma generated with chlorine gas to clean the processing chamber of the plasma processing apparatus could not remove the AlF adhered thereto, so it was necessary to open the processing chamber in the atmosphere and to clean the inner walls of the processing chamber using alcohol or the like. This cleaning method, however, has a drawback in that it takes time to open the processing chamber in the atmosphere, clean the inner walls using alcohol etc. and thereafter evacuate the processing chamber again. Further, since aluminum-based reaction products are deposited gradually on the inner walls of the processing chamber, the reaction products adhered to the walls may fall off from the wall before performing the cleaning process and become particles contaminating the products being processed, or may cause the plasma density and composition to vary or may even cause the etching properties to change, by which the uniformity of the products being processed is deteriorated (for example, refer to patent document 1).

One known method for cleaning the vacuum container proposes removing deposits containing Al with plasma generated using BCl₃ and Cl₂ gases, or BCl₃ and HCl gases (for example, refer to patent documents 2 and 3). Another method proposes removing the deposits containing Al with plasmas each generated using H₂O, Cl₂ and O₂ gases, in sequential manner (for example, refer to patent document 4). Yet another known method proposes removing the deposits containing Si with plasma containing F, such as SF₆ and CF₄.

Furthermore, it has been known that when a gas containing fluorine is used during plasma processing, an aluminum fluoride is generated, which is a stable compound having low vapor pressure, which cannot be removed easily. Various methods for removing aluminum fluoride are known. One method utilizes Cl₂ gas to decompose AlF₃ into AlCl₃ (for example, refer to patent document 5). Another method proposes decomposing and removing AlF₃ using H₂O and Cl₂ (for example, refer to patent document 6). Yet another method proposes removing the aluminum fluoride using oxygen (for example, refer to patent document 7). Yet another method proposes performing cleaning using chlorine or fluorine plasma that does not contain oxygen by which the generation of aluminum fluoride can be suppressed (for example, refer to patent document 8).

The plasma cleaning methods as exemplified above are advantageous in that the cleaning can be performed in a short time since the vacuum container is not exposed to the atmosphere. Furthermore, for example, after processing several-thousand wafers, the vacuum chamber is exposed to the atmosphere to wet-clean the inside of the chamber using water and acid.

Recently, along with the increase in the variation of semiconductor elements, the materials of the wafers and the gases used in the plasma processing have diversified. Therefore, the problem of deposits that cannot be removed by conventional plasma cleaning methods has become more significant. When a material containing Al, such as aluminum (Al)/alumite (anodized aluminum), is used to build the vacuum container, and chlorine-based gas and fluorine-based gas are used either in mixture or alternately, the fluorine reacts with Al or alumina, generating aluminum fluoride (AlF₃). Aluminum fluoride has low vapor pressure and is difficult to remove by plasma cleaning, and along with the complexity of recent processes, the deposition of aluminum fluoride has become a serious problem. Therefore, a more effective method for cleaning the reaction chamber is required for enhancing throughput.

Though a certain degree of cleaning rate is realized by the known methods mentioned above, the cleaning rate of the art disclosed in patent document 5 regarding the method of using only Cl₂ gas is low, and the cleaning rate of the art disclosed in patent document 6 regarding hydrolyzing AlF₃ by H₂O is also not sufficient, since the reaction rate is high in the liquid phase but is low in the gas phase.

Patent document 1
Japanese Patent Laid-Open Publication No. H6-306648

Patent document 2
Japanese Patent Laid-Open Publication No. H11-186226

Patent document 3
Japanese Patent Laid-Open Publication No. 2000-12515

Patent document 4
Japanese Patent Laid-Open Publication No. H9-171999

Patent document 5
Japanese Patent Laid-Open Publication No. H7-130706

Patent document 6
Japanese Patent Laid-Open Publication No. 2001-308068

Patent document 7
Japanese Patent Laid-Open Publication No. 2003-197605

Patent document 8
Japanese Patent Laid-Open Publication No. H9-186143

### SUMMARY OF THE INVENTION

The object of the present invention is to provide a dry cleaning method for removing the aluminum-based reaction products adhered to the interior of the processing chamber and the aluminum or the like sputtered from the material inside the processing chamber in vacuum without exposing the inside of the processing chamber to the atmosphere.

Another object of the present invention is to provide a method for cleaning the plasma processing apparatus for removing the aluminum fluoride in the processing chamber efficiently.

In order to solve the problems of the prior art, the present invention comprises adopting plasma generated using a mixed gas of chorine gas and hydrobromic gas, mounting a silicon wafer on a wafer-mounting electrode, applying a high-frequency power to the silicon wafer and performing dry cleaning, to thereby remove as volatile components the aluminum-based reaction products and the aluminum being sputtered from the members within the processing chamber adhered to the inner walls of the processing chamber.

In order to achieve the above objects, the present invention supplies substances such as Si that react with F and turn into gas, and at the same time, generates halogen gas plasma other than fluorine, such as chlorine or Br. According to the present method, aluminum fluoride can be decomposed and removed.

### BRIEF DESCRIPTION OF THE DRAWINGS

FIG. 1 is a schematic view showing a plasma processing apparatus according to an embodiment of the present invention;

FIG. 2 is a graph showing the effect of high-frequency power applied according to the present invention;

FIG. 3 is an explanatory view showing the overall structure of a plasma processing apparatus according to one embodiment of the present invention;

FIG. 4 is a graph showing the relationship between the bias power and the cleaning rate;

FIG. 5 is an explanatory view showing the overall structure of a plasma processing apparatus according to another embodiment of the present invention; and

FIG. 6 is an explanatory view showing the overall structure of a plasma processing apparatus according to yet another embodiment of the present invention.

### DETAILED DESCRIPTION OF THE PREFERRED EMBODIMENT

The preferred embodiments of the present invention will now be explained with reference to the drawings.

### Embodiment 1

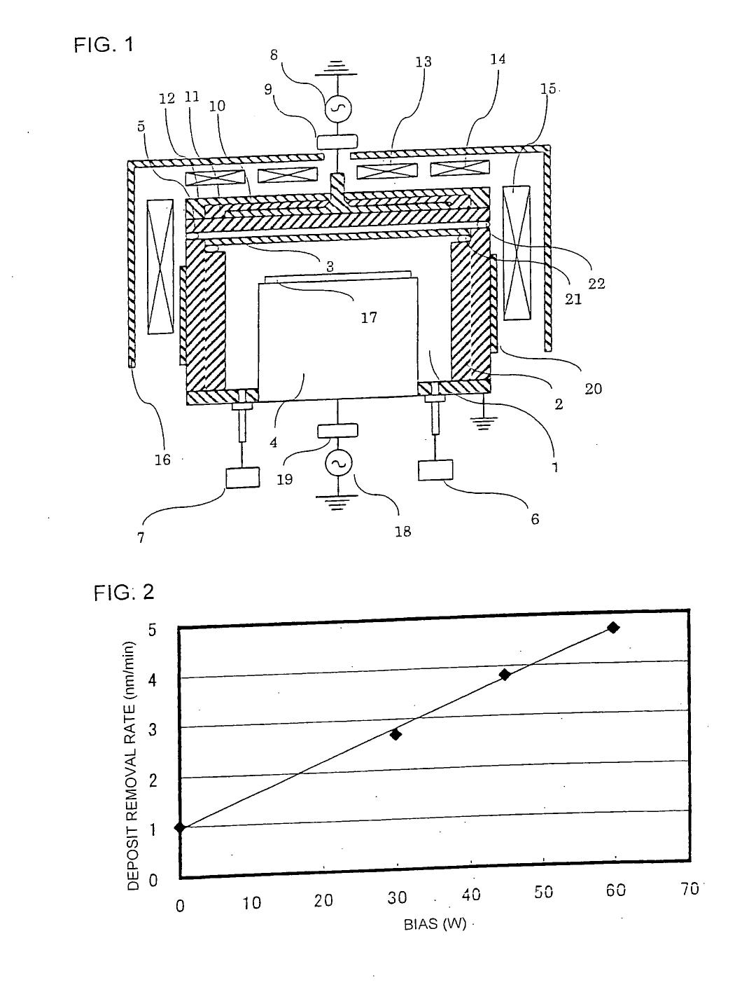

The first embodiment of the present invention will be explained with reference to the plasma etching apparatus shown in FIG. 1. FIG. 1 is an explanatory view showing the outline of the structure of the plasma etching apparatus to which the processing method according to the present invention is applied. A processing chamber 1 of the plasma etching apparatus according to the first embodiment comprises a side wall 2 of the processing chamber, a shower plate 3 made of quartz, a substrate-mounting electrode 4, an evacuation system 7, an antenna 10, and so on. The plasma etching apparatus further comprises a quartz plate 5, a vacuum gauge 6, a high-frequency power supply 8, a matching circuit 9, a dielectric 11, an antenna cover 12, coils 13, 14, 15, a yoke 16, a high frequency power supply 19, a matching circuit 19, a heater 20, and O-rings 21 and 22. On the substrate-mounting electrode 4, a substrate 17 such as a silicon wafer to be processed is mounted and fixed thereto.

The processing gas being supplied into a space defined by an O-ring 22 between a shower plate 3 and a quartz plate 5 from a gas supply system not shown is supplied into the processing chamber 1 through plural holes formed to the shower plate 3.

The pressure inside the processing chamber is measured with a vacuum gauge 6, and the chamber is evacuated through an evacuation system 7 having a pressure control means not shown so that it maintains a predetermined pressure.

The high-frequency power for generating plasma inside the processing chamber 1 is supplied from a high-frequency power supply 8 through a matching circuit 9 to an antenna 10. A dielectric 11 constituting the waveguide for electromagnetic waves and an antenna cover 12 are disposed around the antenna 10. Coils 13, 14 and 15 for generating a magnetic field within the processing chamber 1 are disposed to the outer circumference of the processing chamber 1, and a yoke 16 is disposed so as to prevent the magnetic field formed by the coils from being leaked to the exterior.

A high-frequency power supply 18 for applying a bias voltage to a substrate 17 to be processed mounted on a substrate-mounting electrode 4 is connected thereto via a matching circuit 19.

A heater 20 for heating the side wall of the processing chamber is disposed to the atmosphere-side of the side wall 2 of the processing chamber. An O-ring 21 is disposed between the end of the lower surface of the shower plate 3 and the upper end of the side wall of the processing chamber, and an O-ring 22 is disposed between the end of the upper surface of the shower plate 3 and the end of the lower surface of the quartz plate 5.

Now, the method for etching an object to be processed in the plasma etching apparatus having the structure explained above will be described. For example, Ar (100 ml/min) and CF₄ (50 ml/min) are introduced as processing gas through the shower plate 3 into the processing chamber 1, and the interior of the processing chamber 1 is evacuated through the evacuation system 7 with the pressure controlled to 1 Pa on the vacuum gauge 6.

A power supply capable of generating a high frequency of 450 MHz is used as the high-frequency power supply 8 connected to the antenna 10, and using the same, a high-frequency power of 400 W is supplied to the antenna 10, and an isomagnetic field surface of 0.016 T is formed within the processing chamber by coils 13 through 15, according to which an electron cyclotron resonance occurs on the isomagnetic field surface, causing plasma to be generated efficiently in the processing chamber 1.

When a Si wafer is used as the substrate 17 to be processed, the substrate 17 is etched by the plasma generated in the processing chamber 1. At this time, the high-frequency power supply 18 connected to the substrate-mounting electrode 4 applies a high-frequency power of 400 kHz and 100 W to the substrate 17 to be processed.

In this case, if an aluminum-based material is used to form the processing chamber 1, the aluminum-based material will be sputtered by the Ar used as processing gas, and adheres to the inside of the processing chamber 1, such as to the shower plate 3 made of quarts. A portion of this aluminum-based deposit turns into aluminum fluoride (AlF) by the CF₄ utilized as processing gas.

The deposits such as aluminum or aluminum fluoride adhered to the inside of the processing chamber 1 become the cause of particles and plasma variation. Especially when the shower plate is disposed in confronting relations with the substrate being processed, the influence of deposits to particles and plasma variation is significant. Moreover, if reaction products are adhered to the shower plate, the reaction products falling off from the plate is delivered by the gas flowing through the shower plate and reaches the wafer as particles. Therefore, it is necessary to remove deposits such as aluminum fluoride adhered to the interior of the processing chamber 1.

One example of the processing methods for removing deposits comprises exposing the interior of the processing chamber 1 to the atmosphere and removing, using alcohol or the like, the deposits adhered to the surface thereof, as mentioned earlier. However, the application of this method is not efficient, since it takes up too much time to expose the processing chamber 1 to the atmosphere, to remove the deposits, and to evacuate the chamber again. Further, since this operation depends on manpower, the quality for removing the deposit may differ according to the worker.

Therefore, the present processing method utilizes an Si wafer as substrate 17 to be processed, and mounts the same on the substrate-mounting electrode 4. A hydrobromic (HBr) gas (100 ml/min) and chlorine (Cl₂) gas (100 ml/min) are introduced as processing gases to the processing chamber 1 through the shower plate 3, and the processing chamber 1 is evacuated through the evacuation system 7 with the pressure controlled so that the indication on the vacuum gauge 6 is 1.0 Pa. A high-frequency power of 450 MHz and 500 W is supplied to the antenna 10 from the high-frequency power supply 8, and coils 13 through 15 are set appropriately, so that plasma is generated within the processing chamber 1.

The Si as substrate 17 to be processed is etched, and at the same time, the following plasma reaction occurs in the processing chamber 1.
HBr→H+Br (1)
Cl₂→2Cl (2)

The following reaction occurs between the aluminum fluoride (AlF) adhered to the interior of the processing chamber and the above-mentioned plasma.
AlF+H→Al+HF (3)
Al+3CL→AlCl_{3↑} (4)
Al+3Br→AlBr_{3↑} (5)
4HF+Si→4H+SiF_{4↑} (6)

By the reactions mentioned above, the aluminum-based deposits such as aluminum fluoride adhered to the interior of the processing chamber turn into volatile substances (HF, AlCl₃, AlBr₃, SiF₄) and are evacuated from the processing chamber 1, so according to this method, it becomes possible to remove the aluminum-based deposits.

### Embodiment 2

A second embodiment of the present invention will now be explained with reference to FIGS. 1 and 2. As shown in embodiment 1, by adopting HBr and Cl₂ gases as processing gases for processing the Si wafer or substrate 17, the aluminum-based deposits in the processing chamber can be removed. However, if a high-frequency power of 400 kHz is applied from the high-frequency power supply 18 to the Si wafer or substrate 17 placed on the substrate-mounting electrode 4, the rate for removing the aluminum-based deposits is increased as the high-frequency power applied to the substrate 17 increases.

FIG. 2 shows the result of the rate for removing aluminum fluoride measured with a crystal oscillator film thickness monitor, wherein the first embodiment is shown in which the bias is 0 W, and the second embodiments are shown in which the biases are 30 W, 45 W and 60 W. As can be seen clearly in this chart, the removal rate of aluminum fluoride where no bias was applied was 1 nm/min, wherein the rate was 2.6 nm/min when a bias of 30 W was applied, 3.9 nm/min when a bias of 45 W was applied, and 4.7 nm/min when a bias of 60 W was applied, by which a significant effect was realized.

Generally when high-frequency voltage is applied to the substrate 17 to be processed, the plasma potential varies according to the variation of the high-frequency voltage on the positive voltage side. On the other hand, on the front surface of the side wall of the processing chamber (effective earth portion), an ion sheath is formed according to the plasma. By the ion-assist effect in which the ions are accelerated by the electric field in the ion sheath and collide against the side wall of the processing chamber, the removal rate of aluminum-base deposits is increased.

As the high-frequency voltage applied to the substrate 17 increases, the variation of plasma potential is increased, and the ion-assist effect is enhanced.

Therefore, by applying to the Si wafer the highest possible high-frequency power allowed by the apparatus, the rate for removing the aluminum-based deposits in the processing chamber is increased, and thus, a more effective dry etching becomes possible.

Incidentally, when only either the hydrobromic (HBr) gas or the chlorine (Cl₂) gas was used for processing, the AlF could not be removed efficiently.

The above description explained the case of a dry etching apparatus using Ar/CF₄, but the same effects can be achieved by using other combinations of gases and materials to be processed. Further, the above example utilized a mixed gas of HBr+Cl₂ as cleaning gas, but other gases having reduction functions and gases for etching Al (such as BCL₃) or a mixed gas containing the same can also be used to achieve similar effects.

The above description exemplified a dry etching apparatus of the UHF-ECR system, but dry etching apparatuses using other discharge methods (capacitively-coupled discharge, inductively-coupled discharge, magnetron discharge, surface wave-induced discharge, TCP discharge, etc.) can also be used to achieve equivalent effects. Furthermore, the present invention is not only applied to the plasma dry etching apparatus, but also to other types of plasma processing apparatus such as plasma CVD apparatus, ashing apparatus and surface modifying apparatus, to achieve equivalent effects.

Furthermore, if a material containing silicon, such as quartz, exists within the processing chamber, similar advantageous effects can be achieved without placing a silicon wafer inside the chamber.

According to the present invention described above, it becomes possible to remove the aluminum-based deposits in the plasma processing chamber without exposing the interior of the chamber to the atmosphere. The present invention enables not only to cut down the time required to clean the inside of the processing chamber significantly, but also to maintain the amount of aluminum-based deposits in the processing chamber to below a certain degree, so the property of the plasma and the performance of the process can be maintained constant, and the amount of particles in the chamber can be suppressed to below a certain value. Moreover, since it becomes possible to remove the deposits by adopting certain process conditions, the prior-art problem of the quality of the removal being varied among operators can be solved.

### Embodiment 3

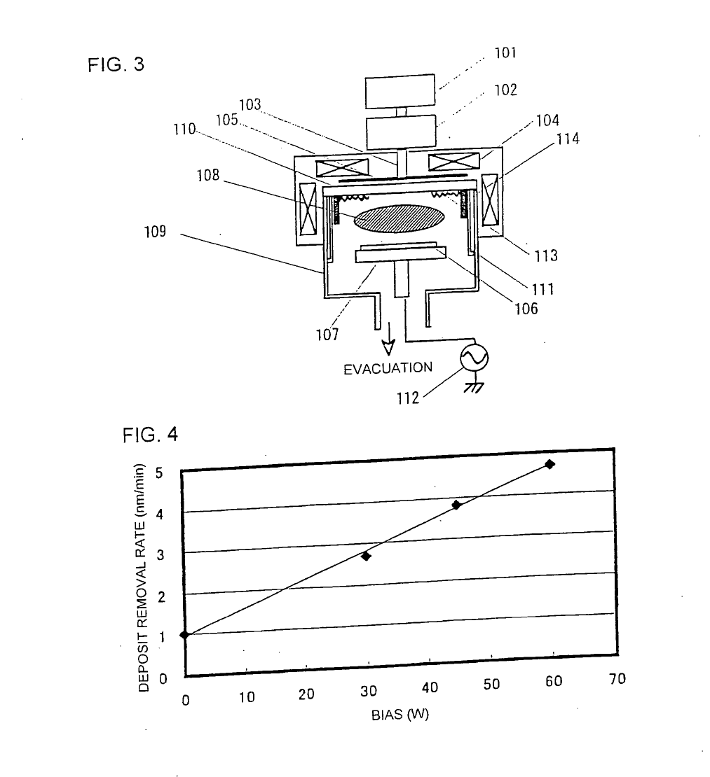

Next, the third embodiment of the present invention will be described with reference to FIG. 3. FIG. 3 shows the overall structure of a plasma etching apparatus, and exemplifies an apparatus that utilizes electron cyclotron resonance (ECR). Electromagnetic waves of 450 MHz are introduced from a UHF power supply 101 via an impedance matching network 102, a waveguide 103 and an antenna 105 into a vacuum container 109. The vacuum container is formed of metal or metal having an insulative coating applied to the inner surface thereof, and the area from which the electromagnetic waves are introduced is an entrance window 110 formed of quartz. Gas is introduced to the vacuum container 109, and plasma 108 is generated by the electromagnetic waves of the UHF band. The magnetic field strength of an electromagnet 104 is set so that it resonates with the frequency of the electromagnetic waves, and the magnetic field strength is set to approximately 0.016 T when the frequency is 450 MHz. By thus setting this magnetic field strength, the electron cyclotron motion within the plasma resonates with the frequency of the electromagnetic waves, so the energy of the waves is supplied efficiently to the plasma, generating high-density plasma.

A wafer 106 is placed on a wafer holder 107. A bias power supply 112 for generating electromagnetic waves in the RF band is connected to the wafer holder 107 so as to accelerate the ions being incident on the wafer. There is no special range set for the frequency of the bias power supply 112, but in this example, a frequency of 400 kHz is utilized. An earth member 111 having an alumite with a thickness that enables high frequency electromagnetic waves to pass therethrough disposed on aluminum is disposed so as to surround the wafer holder 107 as earth for the bias power supply 112. Further, a quartz inner cylinder 114 is disposed on a portion of the side wall of the vacuum container.

Now, the method for etching an object to be processed using the plasma etching apparatus having the above-mentioned structure will be described. For example, Ar (100 ml/min) and CF₄ (50 ml/min) as processing gases are introduced to the vacuum container 109, and the vacuum container 109 is evacuated so that the pressure inside is maintained at 1 Pa.

A power supply capable of generating a high frequency of 450 MHz is utilized as the UHF power supply 101 connected to the antenna 105, from which high-frequency power of 400 W is supplied to the antenna 105. The electromagnet 104 is used to create an isomagnetic field surface of 0.016 T within the processing chamber, by which electron cyclotron resonance occurs on this isomagnetic field surface, and plasma is efficiently generated within the vacuum container 109.

When a Si wafer with a diameter of 200 mm is used as wafer 106, the wafer 106 is subjected to etching by the plasma generated within the vacuum container 109. At this time, the bias power supply 112 connected to the wafer holder 107 applies a high-frequency power of 400 kHz and 100 W to the wafer.

If an aluminum-based material is used to form some member constituting the vacuum container 109, the aluminum-based material will be sputtered by the Ar used as processing gas, and adheres for example to members made of quarts inside the vacuum container 109. A portion of this aluminum-based deposit is fluorinated by the CF₄ used as processing gas, and turns into aluminum fluoride (AlF).

The deposits such as aluminum or aluminum fluoride adhered to the interior of the vacuum container 109 become the cause of particles and plasma variation. Especially when the shower plate having ejection holes formed to a quartz plate for introducing gas to the container is disposed in confronting relations with the wafer to be processed, the influence of deposits to particles and plasma variation is significant. Moreover, if reaction products are adhered to the shower plate, the reaction products falling off from the plate is delivered by the gas flowing through the shower plate and reaches the wafer as particles. Therefore, it is necessary to remove deposits such as aluminum fluoride adhered to the interior of the vacuum container 109.

One example of the processing methods for removing the deposits comprises exposing the inside of the vacuum container 109 to the atmosphere and removing using alcohol or the like the deposits adhered to the surface thereof, as mentioned earlier. However, the application of this method is not efficient, since it takes up too much time to expose the vacuum container 109 to the atmosphere, to remove the deposits, and to evacuate the vacuum container 109 again. Further, since this operation depends on manpower, the quality for removing the deposit may differ according to the worker.

Therefore, the present processing method utilizes a Si wafer as wafer 106, and places the same on the wafer holder 107. A hydrobromic (HBr) gas (100 ml/min) and chlorine (Cl₂) gas (100 ml/min) are introduced as processing gases to the vacuum container 109, and the vacuum container 109 is evacuated through an evacuation system 7 with the pressure within the container 109 controlled to 1.0 Pa. A high-frequency power of 450 MHz and 500 W is supplied to the antenna 105 from the UHF power supply 101, and the electromagnet 104 is set appropriately, to thereby generate plasma within the processing chamber 1.

The Si or wafer 106 is etched, and at the same time, the following plasma reaction occurs in the vacuum container 109.
HBr→H+Br (1)
Cl₂→2Cl (2)

The following reaction occurs between the aluminum fluoride (AlF) adhered to the interior of the processing chamber and the above-mentioned plasma.
AlF+H→Al+HF (3)
Al+3CL→AlCl_{3↑} (4)
Al+3Br→AlBr_{3↑} (5)
4HF+Si→4H+SiF_{4↑} (6)

By the reactions mentioned above, the aluminum-based deposits such as aluminum fluoride adhered to the interior of the vacuum container turn into volatile substances (HF, AlCl₃, AlBr₃, SiF₄) and are evacuated from the vacuum container 109, so according to this method, it becomes possible to remove the aluminum-based deposits.

Next, an example in which high-frequency power is applied to the wafer is described. As mentioned earlier, by adopting HBr and Cl₂ gases as processing gases for processing the Si wafer or wafer 106, the aluminum-based deposits in the vacuum container 109 can be removed. Furthermore, if a high-frequency power of 400 kHz is applied using the bias power supply 112 to the Si wafer or wafer 106 placed on the wafer holder 107, the rate for removing the aluminum-based deposits is enhanced as the high-frequency power applied to the wafer 106 increases.

FIG. 4 shows the result of the rate for removing aluminum fluoride measured with a crystal oscillator film thickness meter. As can be seen clearly in this chart, the removal rate of aluminum fluoride where no bias is applied was 1 nm/min, wherein the rate was 2.6 nm/min when a bias of 30 W was applied, 3.9 nm/min when a bias of 45 W was applied, and 4.7 nm/min when a bias of 60 W was applied, by which a significant effect was realized.

Generally when high-frequency voltage is applied to the wafer 106, the plasma potential varies according to the variation of the high-frequency voltage at the positive voltage side. On the other hand, on the front surface of the side wall of the processing chamber (effective earth portion), an ion sheath is formed according to the plasma. By the ion-assist effect in which the ions are accelerated by the electric field in the ion sheath and collide against the side wall of the processing chamber, the removal rate of aluminum-base deposits is increased.

As the high-frequency voltage applied to the wafer 106 increases, the variation of plasma potential is increased, and the ion-assist effect is enhanced. Therefore, it is estimated that by applying to the Si wafer the highest possible high-frequency power allowed by the apparatus, the rate for removing the aluminum-based deposits in the processing chamber is increased, and thus, a more effective dry etching is enabled.

### Embodiment 4

Here, an example according to the present invention in which the conditions are varied in further detail will be described. The following tests were performed in order to directly measure the degree of deposition of aluminum fluoride to the interior of the vacuum container 109. In order to have deposits adhere to the surface of the entrance window 110, thirteen Si wafers (diameter size 300 mm) were etched continuously in CF₄+Cl₂ discharge. Thereafter, various plasmas were generated in an attempt to remove the deposits 113. Then, the aluminum fluoride in the deposits adhered to the entrance window 110 was subjected to quantitative analysis using a fluorescent X-ray analysis method. The results are shown in Table 1.

TABLE 1
Relationship between cleaning conditions and
amount of Al deposited on entrance window

| | | | | relative |
|---|---|---|---|---|
| | wafer | | bias power | amount of |
| | material on | | per unit | aluminum |
| plasma gas | wafer | bias power | wafer area | fluoride |
| species | holder | (W) | (W/cm²) | (%) |
| no cleaning | | | | 100 |
| SF₆ | Si | 20 W | 0.028 | 100 |
| Cl₂ | SiO₂ | 20 W | 0.028 | 100 |
| Cl₂ | Si | 0 W | 0.028 | 90 |
| Cl₂ | Si | 20 W | 0.028 | 50 |
| Cl₂ | Si | 40 W | 0.056 | 17 |
| Cl₂ | Si | 80 W | 0.11 | 7 |
| HBr + Cl₂ | Si | 80 W | 0.11 | 1 |
| (1:1) | | | | |

Table 1 shows the amount of residual aluminum fluoride or effect of the cleaning in relative values in which the amount of deposited aluminum fluoride after processing thirteen wafers is shown as 100. The cleaning was performed for 360 S. From table 1, it can be seen that aluminum fluoride cannot be cleaned by SF₆. Further, if SiO₂ wafer (Si wafer having its surface covered with SiO₂) is placed on the wafer holder, the aluminum fluoride cannot be cleaned using Cl₂. Further, even if Si wafer is placed on the wafer holder, the effect of cleaning is little when no bias power is applied to the wafer. By placing an Si wafer and by applying 20 W of bias power, the amount of aluminum fluoride is reduced to half, which means that cleaning is performed. The reason why the effect of cleaning is enhanced by applying bias to Si, other than the sputtering effect of the wall mentioned earlier, is as follows. The etching of the Si wafer is scarcely performed when the bias is 0 W, but with a bias of 20 W, the etching rate is approximately 30 nm/min. That is, by applying bias, the amount of Si being supplied is increased, and the effect of the cleaning is enhanced. By adding HBr to Cl₂, the cleaning effect is even further enhanced.

The reason why aluminum fluoride can be removed by supplying Si is because, as mentioned earlier, the Si takes out the F from the aluminum fluoride (AlFₓ) and vaporizes in the form of SiFₓ, and the remaining Al reacts with Cl or Br and vaporizes in the form of AlCl or AlBr. It is not clear why the cleaning effect is enhanced when HBr is mixed in, but it is estimated that H has an effect to help the above reaction.

As explained above, by supplying Si while generating plasma containing Cl or Br, the aluminum fluoride, which was difficult to remove according to the prior art, can be removed speedily.

When the bias power is increased too much to supply Si, the sputtering rate of the earth is also increased undesirably. According to the prior art method, during cleaning, either the Si wafer is not placed on the wafer holder or bias is not applied to the placed Si wafer, so as to suppress discharge of Si and chipping of earth. This drawback is overcome as follows. First, the minimum necessary amount of discharge of Si was seeked. It has been found through experiments that the bias applied to a dummy wafer of 300 mm should be within 20 W (0.028 W/cm²) to 80 W (0.11 W/cm²) to achieve sufficient cleaning effects. By setting the bias power within this range, unnecessary earth chipping can be suppressed, and aluminum fluoride can be removed without supplying excessive Si. When the size of the Si wafer differs, the bias power per unit area is determined accordingly.

Since the amount of Al being deposited during etching differs according to fluorine gas pressure (number of fluorine atoms) and bias power, the Si required for cleaning may be insufficient with the above-mentioned bias power (80 W). In order to solve this problem, the area of the earth was expanded. The earth 111 is a conductor having an impedance allowing bias high-frequency power to pass therethrough, which is disposed on the inner wall of the vacuum container 109 in contact with plasma 108. The plasma is normally generated between the wafer holder 107 and the entrance window 110. The area of the earth was expanded by adjusting the quarts inner cylinder 114. As a result, it has been found that by expanding the earth area to 40% or more of the plasma contact area, the amount of chipping of the earth can be suppressed to an allowable level even when the bias power for cleaning is set to 80 W or higher. The quartz inner cylinder is disposed so as to prevent dispersion of heavy metal contamination such as Fe contained in small quantities in aluminum or alumite. Therefore, reducing of size of the quartz inner cylinder may cause another problem of increase of heavy metal contamination, but this problem can be overcome by reducing the amount of heavy metal in the alumite to 0.1% or smaller. In the apparatus illustrated in FIG. 3, a material formed by anodizing the surface of aluminum (alumite) is used as the earth. The thickness of the alumite must be set to 200 μm or smaller when the frequency of the bias power being supplied is 400 kHz. That is, the thickness should be set to 0.5 f μm or smaller when the frequency is f kHz. Furthermore, if the metal of the chamber is coated by a material other than alumite, the coating must have a thickness equal to or less than the thickness corresponding to the impedance of the above-mentioned alumite capacity.

It is also possible to suppress chipping of the earth by providing a period called breakthrough where bias power is set high (for example, over 80 W) for about 5 to 20 seconds at the start of the cleaning process, and thereafter, reduce the bias power to less than 80 W. The function of the breakthrough is to remove the surface layer such as the naturally oxidized layer formed on the surface of the dummy wafer that cannot be removed easily by low-bias power, so that after the bias power is turned low, the Si surface can be etched to supply sufficient Si. Moreover, it is also possible to mix approximately 2% to 10% oxygen to the cleaning gas, so that the earth is oxidized while cleaning is performed.

The above-described cleaning method aims at removing aluminum fluoride, but if a gas containing carbon, such as CF₄, is used as the etching gas, deposits containing carbon are generated at the same time. In such a case, by cleaning the carbon before cleaning the aluminum fluoride, the cleaning rate of aluminum fluoride is improved. It is effective to use a mixed gas containing SF₆ and oxygen or SF₆ to perform cleaning of carbon. By use of such gases, carbon can be removed by compounds of CS or CO.

### Embodiment 5

Next, the details of a halogen gas that reacts with Al are described. Though it is possible to use a Cl₂ gas by itself or HBr gas by itself, the effect of removing aluminum fluoride was greatest when the mixture ratio of HBr in Cl₂ was 30% to 80%. Moreover, as shown in Table 2, the effect was greatest when the pressure was 2 Pa or greater.

TABLE 2
Relationship between cleaning conditions and
amount of Al deposited on entrance window

| | | | | relative |
|---|---|---|---|---|
| | wafer | | | amount of |
| | material on | | | aluminum |
| plasma gas | wafer | bias power | pressure | fluoride |
| species | holder | (W) | (Pa) | (%) |
| no cleaning | | | | 100 |
| Cl₂ | Si | 20 W | 0.4 | 78 |
| Cl₂ | Si | 20 W | 2.0 | 50 |
| Cl₂ | Si | 20 W | 6.0 | 22 |

Moreover, when Si is supplied from the wafer, the cleaning efficiency is enhanced if the distance between the wafer and the area to be subjected to cleaning is minimized. According to the apparatus illustrated in FIG. 3, the aluminum fluoride tends to deposit mainly on the entrance window 110, so the entrance window and the Si wafer are brought closer. According to experiments, it has been found that it is desirable to set the distance to 135 mm or smaller.

TABLE 3
Relationship between cleaning conditions and
amount of Al deposited on entrance window

| | | | distance | relative |
|---|---|---|---|---|
| | wafer | | between | amount of |
| | material on | | wafer and | aluminum |
| plasma gas | wafer | bias power | window | fluoride |
| species | holder | (W) | (mm) | (%) |
| no cleaning | | | | 100 |
| Cl₂ | Si | 20 W | 155 | 65 |
| Cl₂ | Si | 20 W | 135 | 50 |
| Cl₂ | Si | 20 W | 115 | 33 |
| Cl₂ | Si | 20 W | 105 | 26 |

### Embodiment 6

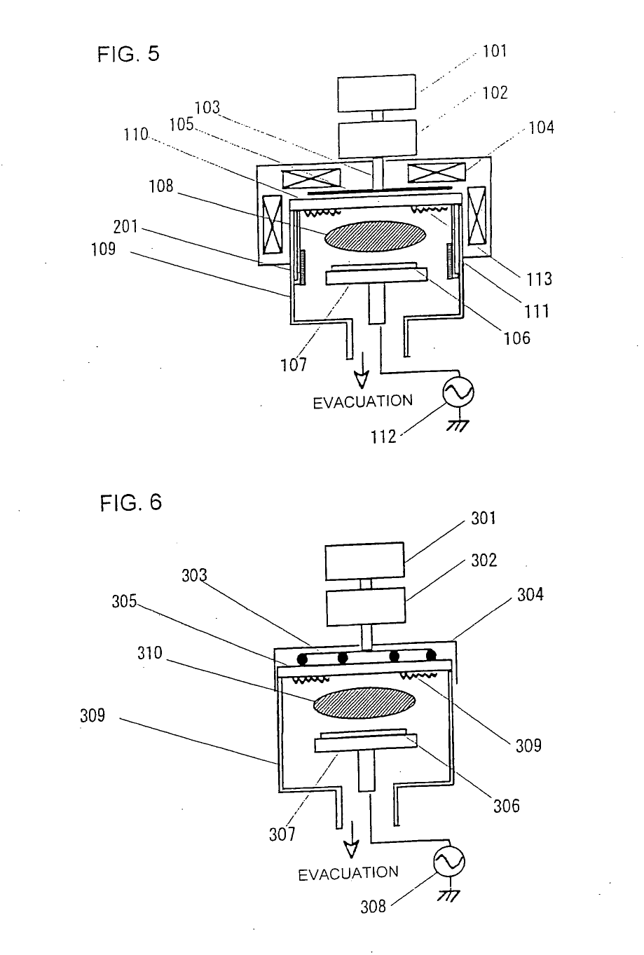

Another method for supplying Si will be described. First, it is possible to supply Si using SiCl₄ or other gases. FIG. 5 illustrates an example in which a material containing Si is used to form a portion of the vacuum container. The Si is supplied by using a ring 201 made either of Si or SiC. The aluminum fluoride can be removed by performing discharge using Cl₂ or HBr for cleaning.

### Embodiment 7

FIG. 6 shows an overall structure of an inductively-coupled plasma processing apparatus. In the present apparatus, electromagnetic waves are supplied from a high-frequency power supply 301 of 13.56 MHz via an impedance matching network 302, a loop antenna 303 and an entrance window 305 into a vacuum container 309. The antenna is covered with a shield 304. Plasma 310 is generated in the vacuum container 309 by inductive coupling from the loop antenna. A bias power of 12 MHz is applied to a wafer holder 307, and a wafer 306 is processed. In the present apparatus, the vacuum container 309 is formed by providing an alumite treatment to the aluminum material surface, and the alumite surface functions as an earth. It is also possible to provide an Al/alumite inner cylinder to cover the inner wall of the container. If wafers are etched using fluorine gas in this apparatus, deposits 309 occur, the main components of which are Al and F, after a certain number of wafers have been processed. These deposits can be removed in the same manner as in embodiment 2, but if the frequency of the bias power is varied, the required power to achieve the same Si wafer etching rate is varied. With a bias frequency of 12 MHz, the power should range between 300 W and 1200 W in order to suppress earth chipping and to supply Si from the wafers, to effectively remove the aluminum fluoride deposited on the entrance window 309. In order to generate plasma, an output of 1 kW from the high-frequency power supply 301 was supplied to carry out a discharge of 2 Pa chlorine gas.

The power required to achieve equivalent Si etching rates for various bias frequencies can be calculated using the following empiric formula. If the power for bias frequency of 400 kHz is P (W), the power Pf (W) for bias frequency f (kHz) required to achieve the Si etching rate that is equivalent to the Si etching rate for 400 kHz is calculated by formula PX (0.00116 f+0.538). This formula can be used for frequencies within the range of 400 kHz to 15 MHz.

### Embodiment 8

The present cleaning method characterizes in vaporizing the Al in the aluminum fluoride in forms of aluminum chloride (AlClₓ) and aluminum bromide (AlBrₓ), and vaporizing the remaining F as a stable compound. Examples of substances other than Si that satisfy these conditions are described below.

The use of mixed gas containing Cl₂ and N₂ enables aluminum fluoride to be removed in forms of AlClₓ and NF₃. By performing cleaning with chlorine whle supplying Ge from a Ge wafer, the aluminum fluoride can be removed in forms of AlClₓ and GeF₄. The use of mixed gas containing Cl₂ and SO₂ enables aluminum fluoride to be removed in forms of AlClₓ and SF₆. The use of Cl₂ and CO₂ enables aluminum fluoride to be removed in forms of AlClₓ and CF₄. The use of Cl₂ and H₂ or HCL enables aluminum fluoride to be removed in forms of AlClₓ and HF.

According to the present invention, the aluminum fluoride deposited on the inner wall of the vacuum apparatus can be removed and cleaned without exposing the interior of the apparatus to the atmosphere, so the yield factor caused by contaminants from deposits during manufacture of devices can be improved. Moreover, the operating rate of the apparatus can be improved since the cycle for cleaning the apparatus in a manner that requires exposing the vacuum container to the atmosphere becomes less frequent.

As described above, the present invention provides a method for processing a plasma processing apparatus having a plasma generating means for generating plasma inside a processing chamber, a high-frequency power applying means for applying high-frequency power to an object to be processed, a processing chamber to which an evacuating device is connected and capable of having its interior evacuated, and a gas supply device for the processing chamber, said method comprising mounting a Si wafer on an electrode for holding the object to be processed, introducing hydrobromic (HBr) gas and chlorine (Cl₂) gas into the processing chamber and generating plasma, and removing an aluminum-based deposit adhered to the interior of the processing chamber. Moreover, according to the present invention, the above-mentioned method for processing the plasma processing apparatus further comprises applying a high-frequency power to the Si wafer on the electrode for holding the object to be processed to remove the aluminum-based deposit adhered to the interior of the processing chamber.

The present invention provides a plasma processing method for generating a plasma in a vacuum container and processing a substrate placed on a substrate holder disposed within the vacuum container, comprising providing a period for generating plasma containing a halogen gas excluding fluorine and an element that reacts with fluorine to create a gas-phase reaction product either each time after processing a wafer or before and/or after processing plural wafers.

The present invention provides a plasma processing method for generating a plasma in a vacuum container and processing a substrate placed on a substrate holder disposed within the vacuum container, comprising providing a period for generating plasma containing a halogen gas excluding fluorine and a Si element either each time after processing a wafer or before and/or after processing plural wafers. Moreover, according to the above-mentioned method of the present invention, a portion of a material constituting the vacuum container contains Al or a stable compound of Al, and a gas containing fluorine is used as gas for processing the wafer with plasma. Furthermore, according to the above-mentioned method of the present invention, the halogen gas excluding fluorine contains either Cl atoms or Br atoms, or both, and the gas plasma being generated contains any one of or a combination of Cl₂, HCl, HBr, BCl₃ and ClF₃.

According to the above-mentioned plasma processing method of the present invention, a method for supplying Si atoms comprises placing a Si wafer, especially a Si wafer with no patterns printed thereon, on the substrate holder when the halogen plasma is discharged, and applying high-frequency power to the Si wafer through the wafer holder. Even further, the amount of the high-frequency power being applied to the Si wafer through the substrate holder corresponds to a frequency of 400 kHz and is equal to or greater than 0.028 W per unit area (1 cm²) of the Si wafer, and preferably equal to or greater than 0.11 W. Moreover, a ratio of an area of an earth to the area of an inner wall of the vacuum container in contact with plasma is 40% or more.

According to the above-mentioned plasma processing method of the present invention, the Si atoms are supplied by including Si to a portion of a material constituting the vacuum container, or by supplying SiCl₄ gas. Further according to the present method, the element that reacts with fluorine to create a gas-phase reaction product is provided by supplying N₂, CO, CO₂, H₂ or SO₂ simultaneously with the halogen gas excluding fluorine.

The above-mentioned plasma processing method of the present invention further comprises providing a period for generating plasma containing SF₆ prior to said period for generating plasma with the halogen gas excluding fluorine.

1. A method for processing a plasma processing apparatus having a plasma generating means for generating plasma within a processing chamber, a high-frequency power applying means for applying high-frequency power to an object to be processed, a processing chamber to which an evacuating device is connected and capable of having its interior evacuated, and a gas supply device for the processing chamber, said method comprising:
mounting a Si wafer on an electrode for holding the object to be processed, introducing hydrobromic gas and chlorine gas into the processing chamber and generating plasma, and removing an aluminum-based deposit adhered to the interior of the processing chamber.

2. The method for processing a plasma processing apparatus according to claim 1, further comprising applying a high-frequency power to the Si wafer on the electrode for holding the object to be processed to remove the aluminum-based deposit adhered to the interior of the processing chamber.

3. A plasma processing method for generating a plasma in a vacuum container and processing a substrate placed on a substrate holder disposed within the vacuum container, comprising:
providing a period for generating plasma containing a halogen gas excluding fluorine and an element that reacts with fluorine to create a gas-phase reaction product either each time after processing a wafer or before and/or after processing plural wafers.

4. A plasma processing method for generating a plasma in a vacuum container and processing a substrate placed on a substrate holder disposed within the vacuum container, comprising
providing a period for generating plasma containing a halogen gas excluding fluorine and a Si element either each time after processing a wafer or before and/or after processing plural wafers.

5. The plasma processing method according to claim 3 or claim 4, wherein
a portion of a material constituting the vacuum container contains Al or a stable compound of Al, and a gas containing fluorine is used as gas for processing the wafer with plasma.

6. The plasma processing method according to any one of claims 3 through 5, wherein
the halogen gas excluding fluorine contains either Cl atoms or Br atoms, or both.

7. The plasma processing method according to any one of claims 3 through 5, wherein
the halogen gas excluding fluorine contains either Cl atoms or Br atoms, or both, and
the gas plasma being generated contains any one of or a combination of Cl₂, HCl, HBr, BCl₃ and ClF₃.

8. The plasma processing method according to any one of claims 3 through 7, wherein
a method for supplying Si atoms comprises placing a Si wafer, especially a Si wafer with no patterns printed thereon, on the substrate holder when the halogen plasma is discharged, and applying high-frequency power to the Si wafer through the substrate holder.

9. The plasma processing method according to any one of claims 3 through 7, wherein
a method for supplying Si atoms comprises placing a Si wafer, especially a Si wafer with no patterns printed thereon, on the substrate holder when the halogen plasma is discharged, and applying high-frequency power to the Si wafer through the substrate holder, wherein the high-frequency power being applied corresponds to a frequency of 400 kHz and is equal to or greater than 0.028 W per unit area (1 cm²) of the Si wafer, and preferably equal to or greater than 0.11 W.

10. The plasma processing method according to any one of claims 3 through 9, wherein
a ratio of an area of an earth to the area of an inner wall of the vacuum container in contact with plasma is 40% or more.

11. The plasma processing method according to claim 4, wherein
Si atoms are supplied by including Si to a portion of a material constituting the vacuum container.

12. The plasma processing method according to claim 4, wherein
Si atoms are provided by supplying SiCl₄ gas.

13. The plasma processing method according to claim 3, wherein
the element that reacts with fluorine to create a gas-phase reaction product is provided by supplying N₂, CO, CO₂, H₂ or SO₂ simultaneously with the halogen gas excluding fluorine.

14. The plasma processing method according to any one of claims 3 through 13, further comprising:
providing a period for generating plasma containing SF₆prior to said period for generating plasma with the halogen gas excluding fluorine.
